(19) United States
(12) Patent Application Publication
(10) Pub. No.: US 2016/0059258 A1
(43) Pub. Date: Mar. 3, 2016

(54) DEVICE FOR COATING AND/OR IMPREGNATING A TEXTILE MATERIAL

(71) Applicant: A. MONFORTS TEXTILMASCHINEN GMBH & CO. KG, Moenchengladbach (DE)

(72) Inventors: Juergen HANEL, Dormagen (DE); Frank BREUER, Erkelenz (DE)

(21) Appl. No.: 14/769,135

(22) PCT Filed: May 6, 2014
(86) PCT No.: PCT/EP2014/059176

§ 371 Date: Sep. 11, 2015

(30) Foreign Application Priority Data
May 14, 2013 (DE) 10 2013 104 921.4

(51) Int. Cl. B05C 1/08; B05C 9/12; D06B 23/20

(52) U.S. Cl. CPC B05C 1/0834; D06B 23/20; B05C 9/12

(57) ABSTRACT

The invention relates to an apparatus for coating and/or impregnating a textile web (1), comprising an intake feeder (2), at least one applicator (3) for finishing agents, and a heat-treatment device (4). The apparatus is improved so as to allow change-overs to different application types quickly and with few human resources. This is achieved by designing the applicator (3) as an exchangeable module.

The invention relates to an apparatus for coating and/or impregnating a textile web, comprising an intake feeder, at least one applicator for finishing agents, and a heat-treatment device.

Such an apparatus is known per se from EP 797 698 [U.S. Pat. No. 5,885,305], for example, and is used in textile finishing to impart certain properties to a textile produced from a web or to apply dyes and/or patterns onto the web.

The web is in particular a woven or a knitted fabric.

The finishing agent is a dye, a dressing, or a synthetic in the form of a liquid, a paste, or a foam.

Coating within the meaning of the present application shall be understood to mean the application of substances (liquor comprising the finishing agents) to one or both faces of a web such that the substances do not penetrate the web or penetrate the same only to a minor degree; the web is in particular not fully permeated by the substances. The coating is carried out by printing or by slop padding, for example.

Impregnating shall be understood to mean that the substances penetrate the web. This is achieved, for example, by dipping or roller application using an excess of the substances. Coating and impregnating are combined under the term application(s).

If the finishing type, and in particular the application type, is to be changed in the known apparatus, very high complexity is required for changing over the applicator.

It is therefore the object of the invention to create an apparatus for coating and/or impregnating a web that can be changed over to different application types quickly and with few human resources.

The object is achieved by the features of claim 1. The applicator is designed as an exchangeable module. The apparatus can thus be adapted very quickly to a desired finishing type by exchanging a first module, for example for coating, with a second module, for example for impregnating. Other parts of the apparatus continue to be used. The exchange may be carried out by hoisting gear (crane), for example; alternatively, a cart is provided onto which the module to be replaced is pushed and exchanged for another from another identical cart. Rails and rollers or wheels are provided to simplify the displacement, for example.

While the design of modules is known, in principle, and described, for example, in GB 959 669 for exchanging pressing rollers or in U.S. Pat. No. 6,725,896 for printing machines, exchanging the rollers does not equate to the exchange of modules, and according to the US patent identical modules are provided that can be bypassed. The known modules can therefore not be applied to the apparatus according to the invention.

The dependent claims relate to the advantageous embodiment of the invention.

In one embodiment, the applicator is on the intake feeder. This results in a short distance that must be overcome between these two units, and deformation or creasing of the web is prevented.

In a further embodiment, the applicator is at the shortest possible distance upstream of the heat-treatment device. Heat treatment of the web may thus directly follow the application of the finishing agent, whereby undesirable, uncontrollable reactions are subsequently avoided.

Moreover, the space in which potentially hazardous vapors can develop should be kept as small as possible and encased with lower complexity, and should be controlled. Any necessary venting complexity is thus likewise minimized.

In a further embodiment, drive units of the applicator are mounted on the intake feeder and can be connected to associated rollers of the applicator by detachable couplings. In this way an exchange of the modules is simplified, and electrical connections do not have to be reconnected. It is also particularly advantageous if pneumatic and/or hydraulic connections are provided with quick-action couplings that close automatically.

In a further embodiment, the applicator is an impregnating unit or a coating unit. In this way, the most important application types can be carried out.

The invention will be described in more detail with reference to the accompanying schematic drawings. In the drawings:

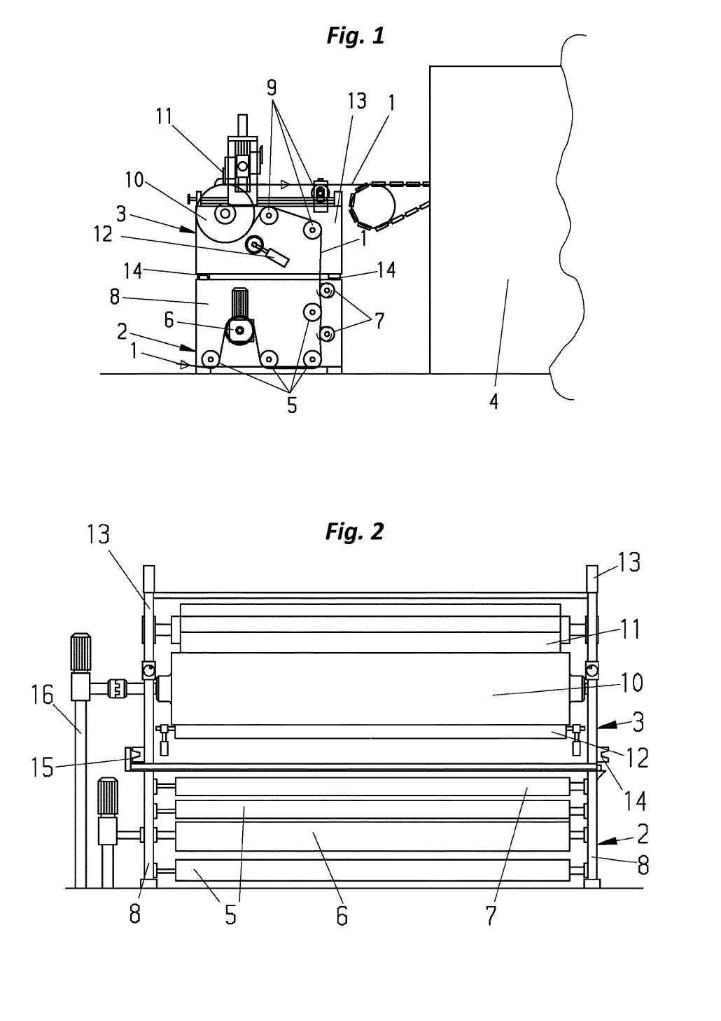

FIG. 1 is a longitudinal sectional view through an apparatus for coating and/or impregnating;

FIG. 2 is a front view of the apparatus;

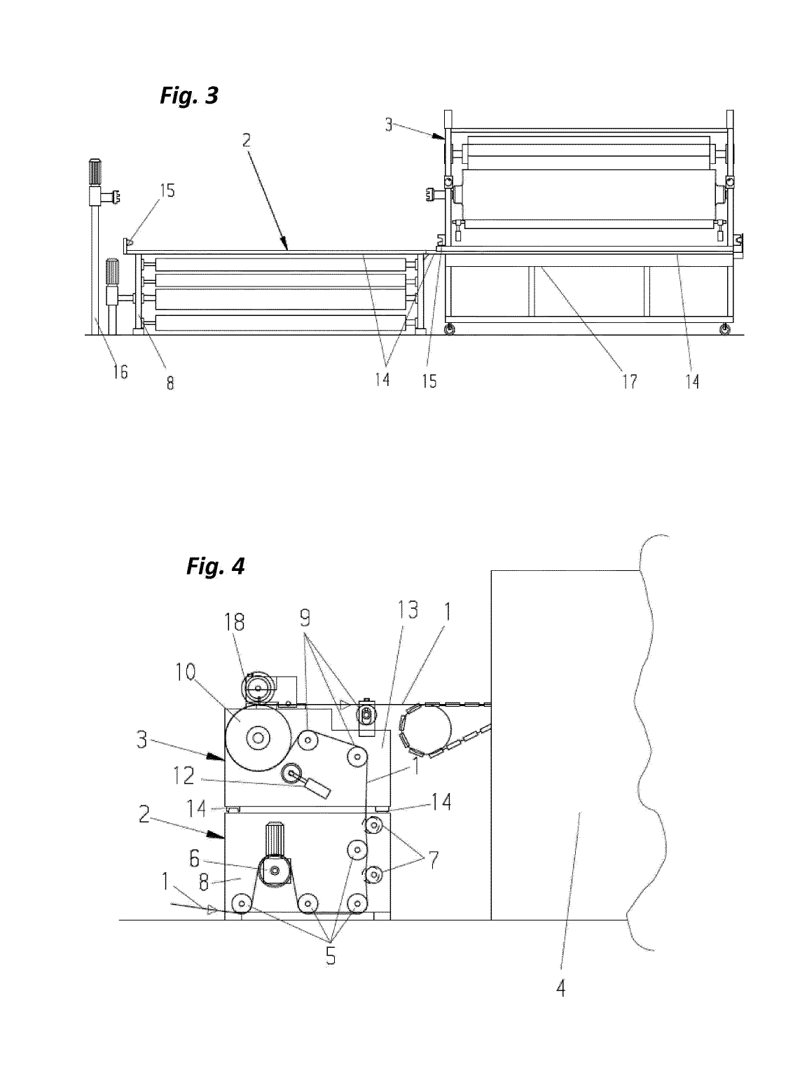

FIG. 3 is a front view of an intake feeder of the apparatus, comprising a ready-to-install module; and

FIG. 4 is a longitudinal sectional view through the apparatus provided with a second embodiment of the inventive module.

As is apparent from FIGS. 1 and 2, an apparatus for coating and/or impregnating a web 1 comprises an intake feeder 2, an applicator 3 here with roller coating, and a heat-treatment device 4. The web 1 can be moved through the apparatus in a transport direction shown by arrow P.

The intake feeder 2 comprises four first deflection rollers 5, a drivable intake roller 6, and two spreader rollers 7. All the rollers 5, 6, 7 are rotatable about respective parallel axes in a machine frame 8. Two of the first deflection rollers 5 with the intake roller 6 and are mounted in a plane therebelow and thus ensure that the web 1 is looped sufficiently around the intake roller 6. One of the first deflection rollers 5 is mounted between the spreader rollers 7 so that they contact the web 1 with sufficient tension.

The applicator 3 is designed as a module and in a first embodiment according to FIGS. 1 to 3 has three second deflection rollers 9, a counter roller 10, a doctor blade 11 having a liquor metering unit for finishing agents, and a pressure roller 12. The doctor blade 11 is designed as a roller blade or a floating blade. In the case of the roller blade, the doctor blade 11 is above the counter roller 10 forming a metering opening; in the case of the floating blade, the doctor blade 11 is above the web 1 between the counter roller 10 that here is used for deflection and tensioning the web 1, and the downstream height-adjustable second deflection roller 9 forms a metering opening. The liquor metering unit is just upstream in the transport direction P of the doctor blade 11, for example in the form of a pipe having orifice nozzles. The counter roller 10 is a drivable roller having a relatively large diameter and has a smooth polished surface. The pressure roller 12 is rubber-coated and can be positioned against the counter roller 10 by a pneumatic or hydraulic drive unit, for example. The second deflection rollers 9, the counter roller 10 and the pressure roller 12 are mounted in a rack 13 that can be pushed onto the machine frame 8 of the intake feeder 2 along guides 14 and aligned precisely therewith by positioners 15 and detachable latches.

The guides 14 are, on the one hand, two rails that are extend parallel to each other on the upper face of the machine frame 8, and, on the other hand, two complementary and downwardly open profiled U- or angular-section rails attached parallel to each other on the lower face of the rack 13. So as to facilitate displacement, sliding or rolling elements are preferably provided.

Drives and electrical and pneumatic and/or hydraulic connections of the applicator 3 are on a separate stand 16 so that they are preferably connected to respective couplings by the positioning and latching engagement steps.

The heat-treatment device 4 that is shown only partially and is designed, for example, as a tenter that is known per se, comprising a pinning or nipping apparatus, is downstream of the applicator 3 in the transport direction.

A storage and transport cart 17 on which the applicator into the apparatus can be stored and transported when outside the apparatus, is provided for the applicator 3. The storage and transport cart 17 comprises a frame mounted on wheels and to whose upper face two parallel rails are attached that correspond to and are spaced like those of the machine frame 8. At least one stop for the applicator is attached to an end of the storage and transport cart 17. The applicator 3 can be pushed from the storage and transport cart 17 onto the machine frame 8, or the applicator 3 can be pushed from the machine frame 8 onto the empty storage and transport cart 17. Centering means on the machine frame 8 and the storage and transport cart 17 and can be used to precisely position the storage and transport cart 17 with respect to the machine frame 8.

In a second embodiment of the module, which is shown in FIG. 4, the applicator 3 is designed as a printing couple that is known per se. It comprises the counter roller 10 and a screen printing roller 18 that form a narrow gap. The counter roller 10 and of the screen printing roller 18 rotatable about parallel axes situated one vertically directly above the other. Perforations corresponding to a predetermined printed image are formed in a shell of the screen printing roller 18 and liquor, here printing paste, is forced in metered quantities through the perforations for application to the web 1 by a doctor blade. The doctor blade and the liquor metering unit are inside the screen printing roller 18. Otherwise, the second embodiment substantially corresponds to the first.

In a third embodiment of the module that is not shown, the applicator 3 is designed as an impregnating system that is known per se. This comprises an immersion trough and its liquor metering unit through which the web 1 is guided by a pan roller, and metering rollers. Otherwise, the third embodiment substantially corresponds to the first.

The number of different embodiments of the applicator 3 that a user of the apparatus keeps available is dependent on the different methods that the user wants to alternately use.

The invention has so far been described in one embodiment in which the module can be displaced sideways on the rails onto the storage and transport cart 17. It is also possible to remove the module upward by a crane. A suitable storage location is then required. The guides and the centering means are then designed in keeping with the vertical removal and insertion of the module. This embodiment is preferably used when space constraints exist next to the system and when web widths are large.

The apparatus is operated in the manner that is customary for the particular application. A distance that the web 1 has to cover between application of the finishing agents and heat treatment is only very short. As a result, the corresponding time period is also very short, so that uncontrolled reactions of the finishing agent on the web 1 can be substantially avoided. A very high quality of the finished web 1 is thus achieved.

Replacement of the applicator 3, which is to say the exchange of one module with another, is carried out as follows:

An empty storage and transport cart 17 is moved close to the intake feeder 2 so that their rails are aligned. The centering means help in this process. As soon as the storage and transport cart 17 is in the correct position, the cart is fixed to the machine frame 8. Any electrical, pneumatic and/or hydraulic connections are detached. The applicator 3 is pushed as a module onto the storage and transport cart 17 and it is uncoupled so that the cart can be moved together with the module to a storage location. From the storage location, another storage and transport cart 17 is moved together with the replacement module to the intake feeder 2, centered, and fixed. The replacement module is pushed onto the intake feeder 2 via the rails, precisely positioned, and detachably attached, and the connections for the electrical drive units are connected automatically. The electrical, pneumatic and/or hydraulic couplings are connected. The replacement module is thus ready for use. In this position, it is also possible to carry out maintenance and repair outside the production machine.

List of reference numerals

| | |
|---|---|
| 1 | web |
| 2 | intake feeder |
| 3 | applicator |
| 4 | heat-treatment device |
| 5 | first deflection roller |
| 6 | intake roller |
| 7 | spreader roller |
| 8 | machine frame |
| 9 | second deflection roller |
| 10 | counter roller |
| 11 | doctor blade |
| 12 | pressure roller |
| 13 | rack |
| 14 | guides |
| 15 | positioners |
| 16 | stand |
| 17 | storage and transport cart |
| 18 | screen printing roller |

1. An apparatus for coating and/or impregnating a textile web, comprising
an intake feeder,
at least one applicator for finishing agents, and
a heat-treatment device,
wherein the applicator is designed as an exchangeable module comprising a counter roller in addition to the applicator.

2. The apparatus according to claim 1, wherein the applicator is on the intake feeder.

3. The apparatus according to claim 1, wherein the applicator is at the shortest possible spacing upstream from the heat-treatment device.

4. The apparatus according to claim 1, wherein drive units of the applicator are mounted separately and can be connected to respective rollers of the applicator by detachable couplings.

5. The apparatus according to claim 1, wherein the applicator is an impregnating unit or a coating unit.
